(19) United States
(12) Patent Application Publication
(10) Pub. No.: US 2026/0245880 A1
(43) Pub. Date: Aug. 20, 2026

(54) MITIGATING CAPACITY LOSS IN BATTERIES WITH VANADIUM BASED POSITIVE ELECTRODES

(71) Applicant: Pure Lithium Corporation, Chicago, IL (US)

(72) Inventors: Brian J. SCHULTZ, Clarence, NY (US); Leonardo GOBBATO, Buffalo, NY (US); Christopher J. PATRIDGE, Tonawanda, NY (US); William J. O'BRIEN, Camillus, NY (US)

(21) Appl. No.: 19/532,285

(22) Filed: Feb. 6, 2026

Related U.S. Application Data
(63) Continuation of application No. PCT/US2024/041813, filed on Aug. 9, 2024.
(60) Provisional application No. 63/518,678, filed on Aug. 10, 2023.

(51) Int. Cl. H01M 4/485; H01M 4/38; H01M 10/052

(52) U.S. Cl. CPC H01M 4/485; H01M 4/382; H01M 10/052

(57) ABSTRACT

A positive electrode material is presented for a rechargeable electrochemical cell that comprises a negative electrode, a positive electrode, and an electrolyte. The positive electrode material comprises a compound with the general formula ζ-AₓM_{y} V₂O₅ and/or ζ-AₓM_{y}N_{z} V_{2-z}O₅, where M and N are transition metals, alkaline earths, alkalis, post-transition metals, metalloids, or a combination thereof and A is one or more ions selected from the group consisting of Li, Na, K, Mg, Ca, Zn, and Al ions. This series of vanadium oxide compounds provides additional electrochemically active ions above the quantity required for cycling that are used to mitigate first cycle capacity losses, also known as formation losses, in secondary batteries.

### CROSS-REFERENCE

This application is continuation of International Application No. PCT/US2024/041813, filed Aug. 9, 2024, which claims the benefit of U.S. Provisional Application No. 63/518,678, filed Aug. 10, 2023, which application is incorporated herein by reference in its entirety.

### STATEMENT AS TO FEDERALLY SPONSORED RESEARCH

This present disclosure was made with government support under STTR Phase 2 Award No. (FAIN) 2112152 awarded by the National Science Foundation. The government has certain rights in the disclosure.

### BACKGROUND

Rechargeable batteries have become an increasingly important part of our daily lives. As more energy intensive applications are looking to use rechargeable batteries, an important concern is the amount of energy that such batteries can store. What is presented is a new material that can be used in rechargeable batteries that has a higher specific capacity to allow rechargeable batteries to store more energy.

### SUMMARY

In some aspects, what is presented is a positive electrode material for a rechargeable electrochemical cell that comprises a negative electrode, a positive electrode, and an electrolyte. The positive electrode material comprises a compound with the general formula ζ-AₓM_{y} V₂O₅ and/or ζ-AₓM_{y}N_{z}V_{2-z}O₅, where M and N are transition metals, alkaline earths, alkalis, post-transition metals, metalloids, or a combination thereof and A is one or more ions selected from the group consisting of Li, Na, K, Mg, Ca, Zn, and Al ions with a concentration of x ranging from 0.0-3.0 during charging and discharging the rechargeable electrochemical cell.

In some variations, the positive electrode material incorporated in the rechargeable electrochemical cell operates in a voltage window between 2.0-4.5 V. In some variations, the positive electrode material incorporated in the rechargeable electrochemical cell operates in a voltage window between 1.5-4.5 V.

In some variations of the general formula ζ-AₓM_{y}V₂O₅ and/or ζ-AₓM_{y}N_{z}V_{2-z}O₅, a concentration of “A” as denoted by “x” is between 0.0 and 3.0. In various embodiments, a concentration of “M” as denoted by “y” is between 0.00001 and 0.66, between 0.00001 and 0.10, or between 0.00001 and 0.08. In various embodiments, a concentration of “N” as denoted “z” is between 0 and 1.33, or between 0 and 0.66, or between 0 and 0.33.

The various embodiments of the general formula ζ-AₓM_{y}V₂O₅ and/or ζ-AₓM_{y}N_{z}V_{2-z}O₅, a concentration of “A” as denoted by “x” is a Li ion between 0 and 3.0, or a Li ion between 0 and 2.0. In other embodiments, a concentration of “M” as denoted by “y” is Na between 0.00001 and 0.66, or Na between 0.00001 and 0.15, or Na between 0.00001 and 0.08.

In another embodiment of the general formula ζ-AₓM_{y}V₂O₅ and/or ζ-AₓM_{y}N_{z}V_{2-z}O₅, a concentration of “A” as denoted by “x” is between 0-3, the concentration of “M” as denoted by “y” is between 0.00001-0.66, and the concentration of “N” as denoted by “z” is 0-1.33.

In another embodiment of the general formula ζ-AₓM_{y}V₂O₅ and/or ζ-AₓM_{y}N_{z} V_{2-z}O₅, a concentration of “A” as denoted by “x” is between 0-3, the concentration of “M” as denoted by “y” is between 0.00001-0.66, and the concentration of “N” as denoted by “z” is 0-1.33.

In another embodiment of the general formula ζ-AₓM_{y}V₂O₅ and/or ζ-AₓM_{y}N_{z}V_{2-z}O₅, a concentration of “A” as denoted by “x” is between 0-3, a concentration of “M” as denoted by “y” is between 0.00001-0.15, and a concentration of “N” as denoted by “z” is 0-1.33.

In another embodiment of the general formula ζ-AₓM_{y}V₂O₅ and/or ζ-AₓM_{y}N_{z}V_{2-z}O₅, a concentration of “A” as denoted by “x” is between 0-3, a concentration of “M” as denoted by “y” is between 0.00001-0.08, and a concentration of “N” as denoted by “z” is 0-1.33.

In another embodiment of the general formula ζ-AₓM_{y}V₂O₅ and/or ζ-AₓM_{y}N_{z}V_{2-z}O₅, a concentration of “A” as denoted by “x” is between 0-3, a concentration of “M” as denoted by “y” is 0.00001-0.15, where “A” is Li, and “M” is Na.

In another embodiment of the general formula ζ-AₓM_{y}V₂O₅ and/or ζ-AₓM_{y}N_{z}V_{2-z}O₅, a concentration of “A” as denoted by “x” is between 0-3, a concentration of “M” as denoted by “y” is 0.0001-0.15, and where “M” is one or more selected from the group consisting of Na, K, Mg, Ca, Pb, Al, Sn, Cs, Rb, and Fe.

In another embodiment of the general formula ζ-AₓM_{y}V₂O₅ and/or ζ-AₓM_{y}N_{z}V_{2-z}O₅, a concentration of “A” as denoted by “x” is between 0-3, a concentration of “M” as denoted by “y” is 0.0001-0.15, a concentration of “N” as denoted by “z” is 0-1.33, and where “N “is from the group consisting of W, Nb, Mo, Zr, Y, Hf, Cr, Sn, Fe, Ti, Mn, Ta, Ce, La, Ni, Si, Ga, Ge, and Co.

In various embodiments, the positive electrode material is incorporated in the rechargeable electrochemical cell in which the negative electrode is one of graphite, carbon, silicon, Li metal, Na metal, Mg metal, Ca metal, Zn metal, Al metal, and a combination thereof.

In various embodiments, the first cycle capacity loss associated with establishing a passivation layer is mitigated by a reservoir of additional “A” ions above the concentration “x” used for cycling the rechargeable electrochemical cell.

In one embodiment, the rechargeable electrochemical cell has a lithium reservoir for passivation layer formation and operates in a voltage window between 2.0-4.5 V for cycling and below 2.0 V to access said lithium reservoir. In another embodiment, in an intermittent charge/discharge cycling protocol, charge/discharge cycles occur between 2.0-4.5 V and on-demand cycles between 1.5-4.5 V to deliver additional capacity to an external circuit. In another embodiment, a continuous charge/discharge cycling protocol cycles from 1.5-4.5 V to deliver capacity to an external circuit.

In some aspects, what is presented is a rechargeable energy source system comprising the positive electrode material disclosed herein.

In some variations, the rechargeable energy source system comprises a negative electrode, wherein the negative electrode is one of graphite, carbon, silicon, Li metal, Na metal, Mg metal, Ca metal, Zn metal, Al metal, and a combination thereof.

In some variations, first cycle capacity loss associated with establishing a passivation layer is mitigated by a reservoir of additional “A” ions above the concentration “x” used for cycling.

In some variations, the rechargeable energy source system further comprises a lithium reservoir for passivation layer formation and operating in a voltage window between 2.0-4.5 V for cycling and below 2.0 V to access said lithium reservoir.

In some variations, the rechargeable energy source system further comprises an intermittent charge/discharge cycling protocol wherein charge/discharge cycles occur between 2.0-4.5 V and on-demand cycles between 1.5-4.5 V to deliver additional capacity to an external circuit. In some variations, the rechargeable energy source system further comprises a continuous charge/discharge cycling protocol cycling from 1.5-4.5 V to deliver capacity to an external circuit. In some variations, the rechargeable electrochemical cell operates in a voltage window between 2.0-4.5 V. In some variations, the rechargeable electrochemical cell operates in a voltage window between 1.5-4.5 V. In some variations, A is selected from the group consisting of Li, Na, K, Mg, Ca, Zn, and Al ions, wherein A has a concentration of x ranging from 0.0-3.0 during charging and discharging the rechargeable energy source system.

In some aspects, what is presented is a rechargeable energy source system comprising: a negative electrode comprising lithium metal, wherein the lithium metal comprises a passivation layer, wherein the passivation layer comprises at least 10% of total lithium in the rechargeable energy source system; and a positive electrode comprising vanadium atoms; wherein the rechargeable energy source system is configured to discharge between 2 and 4.5 V, and wherein the rechargeable energy source system comprises a cycling efficiency of at least 98%.

In some variations, the passivation layer comprises at least 15%, 20%, 25%, 30%, or 33% of all lithium in the rechargeable energy source system. In some variations, the passivation layer comprises at most 15%, 20%, 25%, 30%, 33%, or 40% of all lithium in the rechargeable energy source system. In some variations, the passivation layer is a formation cycle passivation layer.

In some variations, the rechargeable energy source system is configured to discharge between 2.2 V to 4.2 V. In some variations, the rechargeable energy source system is configured to discharge between 2.5 V to 4 V. In some variations, the rechargeable energy source system is configured to discharge between 3 V to 3.5 V. In some variations, the cycling efficiency is at least 98.5%, 99%, 99.5%, 99.6%, 99.7%, 99.8%, or 99.9%. In some variations, the cycling efficiency is at most 98.5%, 99%, 99.5%, 99.6%, 99.7%, 99.8%, 99.9%, or 99.95%, or 99.99%.

In some variations, the positive electrode comprises V₂O₅. In some variations, the V₂O₅ comprises 2-V₂O₅. In some variations, the V₂O₅ comprises nanostructures. In some variations, the nanostructures comprise nanowires. In some variations, the V₂O₅ comprises microstructures. In some variations, the microstructures are nonspherical and have an aspect ratio. In some variations, the V₂O₅ comprises microstructures and/or nanostructures. In some variations, the aspect ratio is at least 2, 3, 4, 5, 10, 15, 20, or 50 between the length and width of the microstructures or nanostructures.

In some aspects, what is presented is a rechargeable energy source system comprising: a negative electrode comprising lithium metal, wherein the lithium metal comprises a passivation layer, wherein the passivation layer comprises at least 10% of all lithium in the rechargeable energy source system; and a positive electrode comprising vanadium atoms; wherein the rechargeable energy source system is configured to discharge at voltages that includes a range from 3 V to 3.5 V, and wherein the rechargeable energy source system comprises a cycling efficiency of at least 98%.

In some variations, the range comprises from 3 V to 4 V. In some variations, the range comprises from 2.5 V to 3.5 V. In some variations, the range comprises from 2.5 V to 4 V. In some variations, the range comprises from 2.2 V to 4.2 V. In some variations, the range comprises from 1.5-4.2 V. In some variations, the range comprises from 1.0-4.5 V.

In some aspects, what is presented is a method of using a rechargeable energy source system, comprising: (a) providing a negative electrode and a positive electrode, wherein the positive electrode comprises vanadium atoms and lithium ions; (b) forming a passivation layer on the negative electrode by transferring the lithium ions to the negative electrode at a first range of voltages; and (c) discharging the rechargeable energy source system to transfer the lithium ions from the negative electrode to the positive electrode at a second range of voltages, wherein the second range of voltages is narrower than the first range of voltages.

In some variations, the first range comprises 0 V to 4.5 V. In some variations, the first range comprises 1.5 V to 4 V. In some variations, the first range comprises 2 V to 4 V. In some variations, the first range comprises 1.5 V to 4.2 V. In some variations, the second range comprises from 2 V to 4.5 V. In some variations, wherein the second range comprises from 2.2 V to 4.2 V. In some variations, the second range comprises from 2.5 V to 4 V. In some variations, the second range comprises from 3 V to 3.5 V. In some variations, the second range comprises from 3 V to 4 V. In some variations, the range comprises from 1.0 to 4.5 V.

In some variations, the positive electrode comprises V₂O₅. In some variations, the V₂O₅ comprises 2-V₂O₅. In some variations, the V₂O₅ comprises nanostructures. In some variations, the nanostructures comprise nanowires. In some variations, the V₂O₅ comprises microstructures. In some variations, the microstructures are nonspherical and have an aspect ratio. In some variations, the V₂O₅ comprises microstructures and nanostructures. In some variations, the aspect ratio is at least 2, 3, 4, 5, 10, 15, 20, or 50 between the length and width of the microstructures or nanostructures.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a graph showing capacity retention versus the cycle life of a rechargeable battery based on the theoretical coulombic efficiency of a rechargeable battery with no extra or additional electrolyte ions, in this case Li ions.

FIG. 2 is a graphic showing the crystallographic arrangement of vanadium atoms (gray spheres surrounded by square pyramid) and oxygen atoms (small black spheres) in α-V₂O₅.

FIG. 3 is a graphic showing the crystallographic arrangement of vanadium (gray spheres surrounded by square pyramids or octahedra) and oxygen atoms (small black spheres) in ζ-V₂O₅.

FIG. 4 is a schematic design of a battery with a positive electrode, a negative electrode, a separator and a cell casing on the left and a schematic of a laminated lithium-metal layer on a graphite negative electrode that serves as the lithium source when ζ-Li₀Mₓ V₂O₅ is used with an unlithiated negative electrode.

FIG. 5 graphs intermittent variations to the voltage window cycling protocol with the first nine cycles between 2.2-3.8 V the tenth cycle from 1.5-3.8 V.

FIG. 6 graphs continuous cycling of specific voltage windows at the same 0.5C charge and 1C discharge rate in a zeta vanadium oxide (“ZVO”) Li-metal battery.

FIG. 7 is a graph of a ZVO positive electrode electrochemical discharge curve when paired with a lithium-metal negative electrode in an electrochemical cell with commercial electrolytes and separators.

FIG. 8 is a graph of a ZVO positive electrode electrochemical discharge curve when paired with a lithium-metal negative electrode in an electrochemical cell with commercial electrolytes and separators with the ZVO formation cycle at 55° C.

FIG. 9 is a ZVO versus LFP specific capacity discharge curve.

FIG. 10 is a ZVO versus LFP specific capacity discharge curve from 4.2-2.2 V.

FIG. 11 is a ZVO versus LFP, NMC 532, and NMC 811 specific capacity discharge curves.

FIG. 12 graphs ZVO specific capacity of multiple batteries versus cycle life.

FIG. 13 is a ZVO specific capacity versus voltage curves for charge and discharge during formation and after formation.

FIG. 14 graphs ZVO first cycle specific capacity during discharge from 4.2-0.1 V when paired with a lithium-metal negative electrode.

### DETAILED DESCRIPTION

Batteries are an electrochemical energy storage system, which can be composed of a positive electrode (sometimes called a “cathode”), a negative electrode (sometimes called an “anode”), a separator, and an electrolyte/solvent combination (simply referred to as “electrolyte” herein). While the battery is being used, or discharged, ions spontaneously travel in the electrolyte from the negative electrode through the separator to the positive electrode as electrons move in an external circuit generating an electrical current. This electric current generation is not infinite and over time and use, the battery loses its ability to generate an electric current. Rechargeable batteries can reverse the process and “charge” the battery to store energy for later use and discharge. While the battery is being charged, an applied electrical current causes ions to travel in the electrolyte from the positive electrode through the separator to the negative electrode. A negative electrode refers to the electrode that is negatively charged during the charging of a rechargeable battery, and positively charged during the discharging of a rechargeable battery. The negative electrode can refer to the electrode where a reduction half-reaction occurs during charging, and an oxidation half-reaction occurs during discharging. A positive electrode can refer to the electrode that is positively charged during the charging of a rechargeable battery, and negatively charged during the discharging of a rechargeable battery. The positive electrode can refer to the electrode where an oxidation half-reaction occurs during charging, and a reduction half-reaction occurs during discharging. Lithium-ion batteries are typically designed with lithium content limited to that which is stored in the positive electrode material or found in the electrolyte.

During the first charge of a rechargeable battery, lithium can be removed from the positive electrode, transported through the electrolyte, and can be inserted or intercalated within the negative electrode. This newly removed lithium from the positive electrode can be highly reactive with the electrolyte, positive electrode interface, and negative electrode interface. Of the lithium removed from the positive electrode in this first charge, 12-30% might not be reinserted to the positive electrode upon discharge, depending on the configuration of the battery and the composition of its components. As a result, significant energy or lithium capacity can be lost during this first charge/discharge cycle, which can be referred to in the battery industry as the formation cycle(s). During formation cycling, the loss of lithium capacity can be referred to as first cycle capacity loss, first cycle irreversible capacity loss, or first cycle coulombic efficiency. An opportunity to significantly increase the capacity and energy density of batteries exists if first-cycle capacity loss can be mitigated.

First cycle capacity loss may occur for various positive electrode materials (such as lithium cobalt oxide (LCO), lithium nickel manganese cobalt oxide (NMC), lithium nickel cobalt aluminum oxide (NCA), lithium manganese oxide (LMO), lithium iron phosphate (LFP), etc.) or for various negative electrode materials (such as graphite, hard carbon, graphite/silicon mixtures, silicon, anodeless designs, lithium-metal, lithium titanate (LTO), etc.). A prediction of first cycle capacity loss based on positive electrode, electrolyte, and negative electrode choice is complicated but there are a few general trends that are often observed. For example, it has often been shown that negative electrodes based on graphite have a first cycle capacity loss between about 7-12%. With a silicon negative electrode, first cycle capacity loss ranges were observed to be from 10-30%. Without being bound to a particular theory, the cause of first cycle capacity loss can be attributed to: (1) irreversible reactions with the electrolyte, (2) irreversible structural changes on surfaces including solid electrolyte interphases, and/or (3) slow kinetics for lithium intercalation. It is likely that a combination of these causes and/or other irreversible processes contribute to first cycle capacity loss.

The negative electrode and positive electrode electrolyte interfaces (the passivation layer, the solid electrolyte interphase, or SEI, hereinafter “the passivation layer”) may be established during the formation cycles and are a significant contributing factor in the first cycle capacity loss but may also serve to stop further reaction of the electrolyte at the passivation layer. The passivation layer can have the properties of a solid electrolyte. Proper passivation layer formation may be critical for long cycle life, low self-discharge rates, and generally a more stable rechargeable battery system. A variety of compounds have been observed on graphite negative electrode passivation layer, including but not limited to lithium fluoride (LiF), lithium carbonate (Li₂CO₃), lithium methyl carbonate (LiOCO₂CH₃), lithium ethylene dicarbonate (LiOCO₂CH₂)₂, and lithium oxide (Li₂O).

The passivation layer properties can change over the lifetime of the rechargeable battery. For example, the thickness of the passivation layer is often observed to increase as the rechargeable battery ages (e.g., on graphite negative electrodes). The growth of the passivation layer could be due to various reasons including diffusion of solvent molecules through the existing passivation layer and/or newly exposed electrode surfaces which result from cracking and deposition of side reaction products such as plated lithium metal and/or transition metal ions dissolved from the positive electrode which then react with the electrolyte to form new passivation layers. Without being bound to a particular theory, the passivation layer growth rate is often observed to correlates approximately with the square root of time: as the passivation layer thickness increases, the rate of solvent molecule diffusion slows down hindering charge and discharge rate performance.

The passivation layer can begin to form as soon as the electrode is exposed to electrolyte and can grow with aging regardless of use. Furthermore, high temperatures can increase diffusion rates and hence also the passivation layer growth rate. High current densities can also lead to particle cracking, newly exposed electrode interfaces, and additional passivation layer formation.

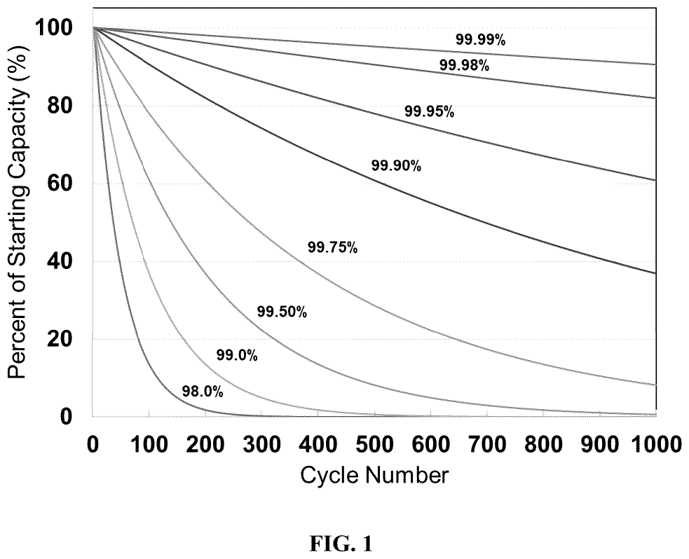

After first cycle capacity loss, batteries ideally transport the same total number of lithium ions (coulombs) back and forth between the positive electrode and negative electrode during cycling; however, a small fraction may become trapped or inactive mostly within passivation layers associated with both electrodes. These losses can be measured as coulombic efficiency (CE). CE % can be defined as the discharge capacity divided by the charge capacity multiplied by 100. As shown in FIG. 1, to achieve a high number of cycles at the battery's end of life (EOL), which can be defined as at least 80% of the post formation starting capacity, CE % must be sufficiently high. The trendlines in FIG. 1 are calculated based upon (CE)^{(cycle number)} and demonstrate the theoretical sensitivity of cycle life to CE.

For rechargeable batteries designed with a balanced lithium capacity between the negative electrode and positive electrode (commonly referred to as the N to P ratio), the profiles in FIG. 1 demonstrate the need for CE % to be greater than 99.98% to achieve over 1000 usable cycles before 80% EOL. In Table 1, below, the theoretical end of life of a rechargeable battery defined as 80% EOL capacity retention are listed for increasing values of coulombic efficiency.

TABLE 1
End of life (EOL) of a rechargeable battery defined as 80% capacity
retention based on theoretical coulombic efficiency.

| | End of Life Cycles to |
|---|---|
| CE % | 80% |
| 98.00 | 11 |
| 99.00 | 22 |
| 99.50 | 45 |
| 99.75 | 89 |
| 99.90 | 223 |
| 99.95 | 446 |
| 99.98 | 1116 |
| 99.99 | 2231 |

Given the advantages to mitigating first cycle losses, a wide variety of solutions have been investigated in the positive electrode, negative electrode, and electrolyte with varying degrees of success, but no solution has yet completely addressed first cycle capacity loss. To address first cycle capacity loss, pre-lithiation reagents, artificial passivation layers, electrolyte additives, over-lithiated positive electrodes, etc. have been explored. Artificial interfaces composed of boron oxides, aluminum oxides, zirconium oxides, niobium oxides, etc. have also been designed on the negative electrode and positive electrode surfaces. The artificial interfaces have been demonstrated to improve columbic efficiency and first cycle capacity loss but do not mitigate either challenge completely. Furthermore, attempts to add extra lithium to positive electrode materials have been reported in literature. The extra specific capacity is not a characteristic of the positive electrode material but instead is introduced into the system through various synthetic routes to achieve over-lithiation.

Most commercial lithium-ion batteries are designed such that the negative electrode has a higher initial starting capacity than the positive electrode by about 10-20%. If the capacity of the positive electrode is larger than the negative electrode, the formation cycle has a high probability of depositing lithium metal on the negative electrode surface. In practice, a 10-20% overage at the negative electrode often overcomes real capacity variations during manufacturing and builds a level of safety tolerance for all lithium-ion rechargeable batteries.

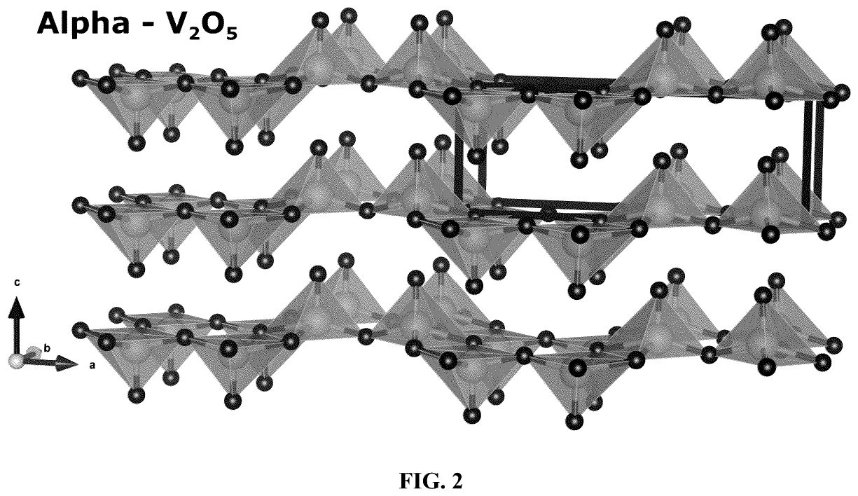

The high valence vanadium pentoxide, where vanadium exists in the +5 oxidation state and oxygen in the −2 oxidation state, may crystallize in the orthorhombic (Pmna) structure. In the Pmna structure, atomically there are alternating pairs of V₂O₅ corner-sharing square pyramidal polyhedra that edge-share with polyhedra pointing in opposite directions along the crystallographic c-axis as shown in FIG. 2. This two-dimensional layered structure is commonly referred to as the alpha phase (α-V₂O₅). This initial V₂O₅ framework can undergo numerous layer shifts and develop shear planes that rearrange into alternate phases still described as V₂O₅. These polymorphic phases include the alpha (α), beta (β), and gamma (γ), that can be described using an orthorhombic, monoclinic, or triclinic system. The polymorphs of the V₂O₅ maintain the V⁺⁵ oxidation state. All these structures can provide significant amounts of empty interstitial space that can accommodate inserted species that makes vanadium oxide a strong candidate for electrochemical intercalation batteries. Without being bound to a particular theory, electrochemical lithiation of V₂O₅ described by the formula Liₓ V₂O₅ can reach a limit of x=3 in the structure however, when x>1 the lithium ions become irreversibly trapped in the vanadium oxide framework. Some work has shown the alpha phase has a sequential phase transformation to four different lithiated phases named, epsilon (ε), delta (δ), gamma (γ), and finally (ω). Pre-intercalation of other elements into V₂O₅ can yield the beta structure (β-MₓV₂O₅). This structure belongs to the general class of compounds known as bronzes in that the inserted alkali or transition metal maintains the same β-MₓV₂O₅ crystalline structure, where x can be 0.33 or 0.66. The addition of other elements while maintaining the V₂O₅ structure can cause a change in the electronic structure of the vanadium oxide due to charge neutrality with the intercalated elements remaining in an ionic state and vanadium is proportionately reduced from V⁵⁺ to V⁴⁺ and/or V³⁺ depending on the oxidation state and amount of intercalant. The stoichiometry for the pre-intercalated templated synthesis ion is determined by both the β-V₂O₅ lattice space available and the ionic radii of the chosen element. It has been demonstrated that Na or Ag ions can incorporate at ~0.33 but for smaller ions such as Li or Cu they can incorporate at ~0.66. In both cases, there is a proportionate reduction of vanadium to an average of approximately +4.84 oxidation state for x=0.33 and approximately +4.66 for x=0.66 and it is assumed the Li, Ag, and Cu all exist at an oxidation state of +1 in the crystalline structure of β-MₓV₂O₅.

To increase the electrochemical performance of these vanadium oxide phases, the M ion concentration can be finely controlled and tuned thereby increasing the usable specific capacity and significantly opening the structure promoting faster charge and discharge rates. Herein, vanadium pentoxide compounds can be written as ζ-M_{y} V₂O₅ and ζ-M_{y}N_{z}V_{2-z}O₅ where M and N are interstitial or substitutional elements, respectively the concentration M is denoted by y can be less than 0.15. These phases where the concentration of M denoted by y is greatly below 0.33 can be referred to as zeta phases. It is worthwhile to note that there are residual M and N ions impact the structure stability, electrochemical stability, and performance of the material in a battery.

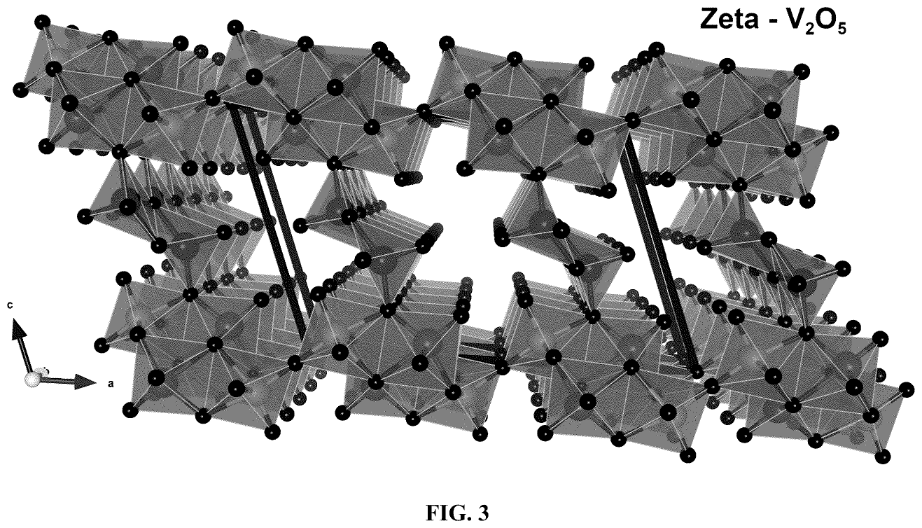

In some aspects, what is presented herein relates to the electrochemical reaction of ζ-V₂O₅ (zeta vanadium oxide, ZVO) as shown in FIG. 3 and derivative compounds such as ζ-AₓM_{y} V₂O₅ and ζ-AₓM_{y}N_{z} V_{2-z}O₅ that are incorporated into a positive electrode material to provide an extra lithium reserve at the positive electrode to overcome capacity losses during cycling without the need to add any additional chemical, component, or positive electrode material. In ζ-AₓM_{y}N_{z}V_{2-z}O₅, A can be one or more ions selected from the group consisting of Li, Na, K, Mg, Ca, Zn, and Al. The concentration of x can range from 0.0-3.0 during charging and discharging the rechargeable electrochemical cell. M can be a transitional metal, alkaline earth, alkali, post-transition metal, metalloid, or combination thereof. In some variations, y can range from 0.0001-0.66. N can be a transition metal, post-transition metal, metalloid, or combinations thereof. In some variations, z can range from 0-2. The terms ζ-V₂O₅, V₂O₅, or ZVO may be used interchangeably to include all derivates of the vanadium oxide compounds including ζ-V₂O₅, ζ-AₓV₂O₅, ζ-AₓM_{y}V₂O₅, and ζ-AₓM_{y}N_{z}V_{2-z}O₅ in various states of charge ranging from fully lithiatied (3 Li) to unlithiated (0 Li).

The positive electrode material can be incorporated into a positive electrode. The positive electrode can be a mixture of the ZVO positive electrode material, a polymeric binder (such as polyvinylidene fluoride), conductive additives (such as, carbon blacks, graphite, carbon nanotubes, graphene, etc.), or any combination thereof, that are deposited on a current collector, typically aluminum. The ZVO positive electrode material can comprise the chemical compound in the positive electrode that intercalates ions and is responsible for generating the electrochemical potential. The conductive additive can be a form of carbon that acts to electrically connect the ZVO positive electrode materials to the current collector. The polymeric binder can hold the ZVO positive electrode material and conductive additives together through cohesion. The polymeric binder can hold the entire deposited layer on the current collector.

The negative electrode can be a mixture of negative electrode active material (anode active material; AAM), polymeric binder (such as carboxymethyl cellulose and styrene-butadiene rubber), conductive additives (such as carbon blacks, graphite, carbon nanotubes, graphene, etc.), or any combination thereof. The negative electrode material can be deposited on a current collector, typically copper. The AAM can comprise a chemical compound that intercalates ions and is responsible for generating the electrochemical potential. The AAM is typically graphite, graphite/silicon mixtures, silicon, or lithium-metal. The conductive additive is typically a conductive form of carbon that acts to electrically connect the AAM materials to the current collector. The polymeric binder holds the AAM and conductive additives together through cohesion and holds the entire deposited layer on the current collector. In some variations, the negative electrode can comprise lithium metal, e.g., without AAM.

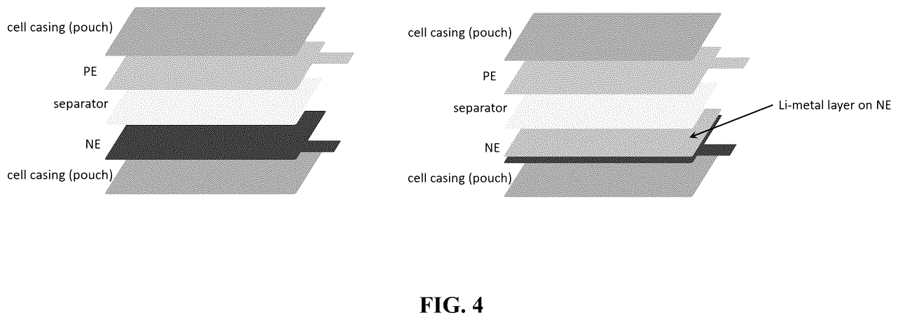

Battery architectures can combine the positive electrode and negative electrode with a separator or a membrane, which can be dispersed in electrolyte, and housed within a cell casing system. FIG. 4 is a schematic that depicts the positive electrode, negative electrode, and separator layers of battery, in accordance with some variations. The negative electrode, positive electrode, separator, and electrolyte material composition options are numerous. The material compositions, cell designs, and cell formats listed above are representative examples and are not intended to be an exhaustive list.

In an electrochemical energy storage system ZVO can undergo the following reaction below.

$$3 {Li}^{+} + {V}_{2} {O}_{5} \to L {i}_{3} {V}_{2} {O}_{5} \qquad Equation 1$$

Lithium-ions in Equation 1 can be replaced with other metal ions such as Na, Mg, K, Ca, Zn, Al, or other generally known electrochemical intercalation ions. In ζ-AₓM_{y}V₂O₅, and ζ-AₓM_{y}N_{z} V_{2-z}O₅ this is represented by the concentration of A as denoted by x.

The theoretical specific capacity, C_{T}, can follow the Equation 2 below:

$${C}_{T} = ( n \cdot F ) / ( 3.6 \cdot {M}_{W} ) \qquad Equation 2$$

where Nis the number of electrons participating in the electrochemical reaction, F is Faraday's constant (96,485.33 C/mol), 3.6 is a constant that converts theoretical specific capacity from C/g to mAh/g, and Mw is the molecular weight in g/mol of the positive electrode material chemical composition. Equation 2 results in 442 mAh/g of theoretical specific capacity when 3 lithium ions participate in the electrochemical reaction and the Mw is 181.88 g/mol V₂O₅. Equation 2 results in 396.66 mAh/g of theoretical specific capacity when 3 lithium ions participate in the electrochemical reaction and the M_{w} is 202.7 g/mol Li₃ V₂O₅.

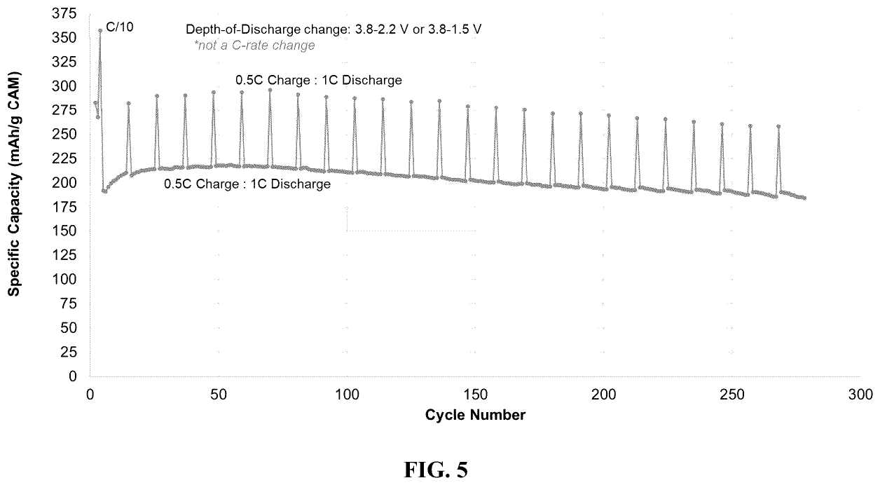

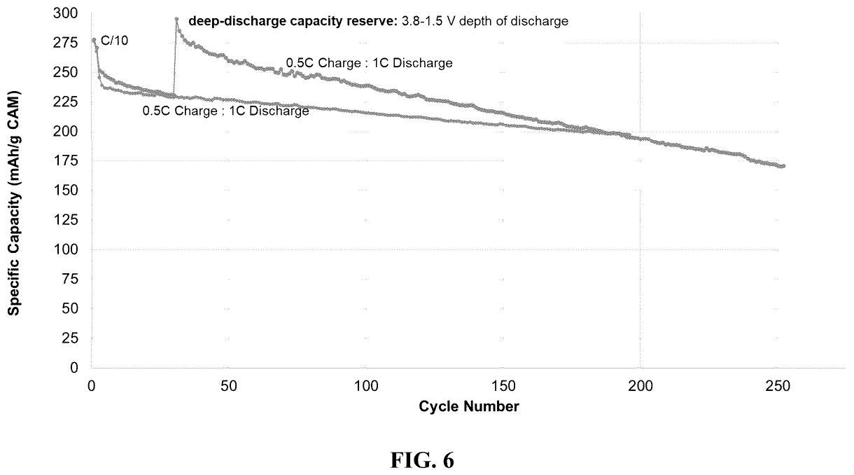

All three lithium-ions can be cycled intermittently or continuously as shown in FIGS. 5 and 6 in LiₓZVO where x ranges from 0-3 because the zeta structure and corresponding M and N stabilize the crystallographic structure. In ZVO lithium-ion batteries, two of the three available lithium-ions can be used during electrochemical cycling with a theoretical maximum of 295 mAh/g from 4.2-2.2 V based on a M_{w} of 181.88 g/mol. The remaining lithium-ion can have an insertion voltage that occurs below 2.2 V with a lower cutoff voltage in the range of 1.8-1.5 V.

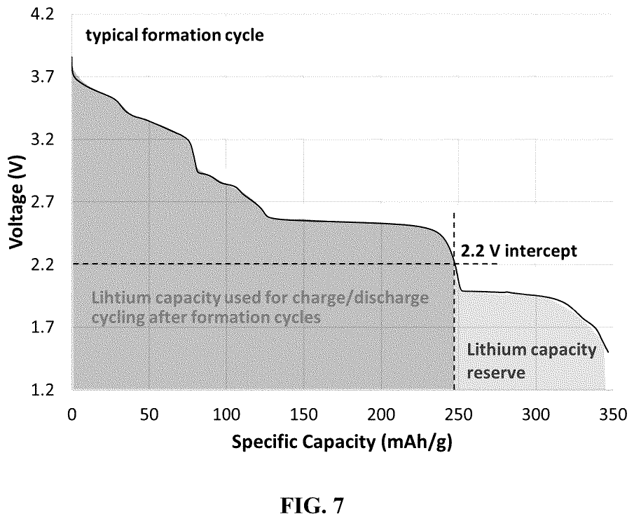

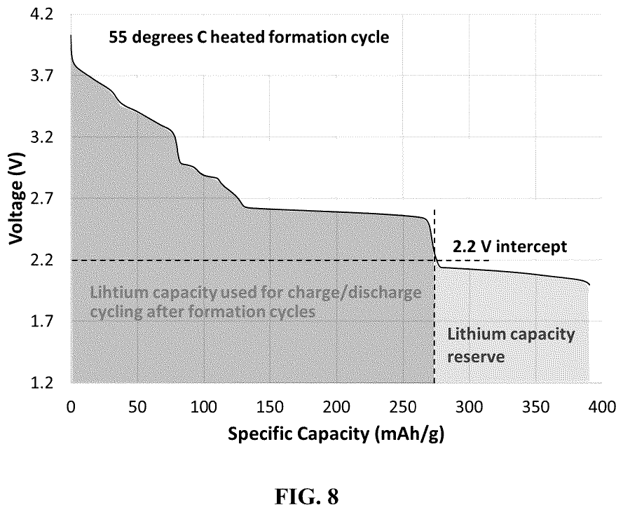

FIGS. 7 and 8 represent ZVO positive electrode electrochemical discharge curves when paired with a lithium-metal negative electrode in an electrochemical cell with commercial electrolytes and separators. FIG. 7 depicts a ZVO formation cycle with specific capacity versus voltage in an electrochemical discharge curve from 4.2-1.5 V at room temperature. The capacity from 4.2-2.2 V can be used for charge/discharge cycling and is demarcated by the dark gray area under the curve. The capacity from 2.2-1.5 V can be used as a lithium capacity reserve and is demarcated in light gray. The lithium capacity reserve can add 40% more capacity from 2.2-1.5 V. FIG. 7 demonstrates a usable specific capacity of approximately 250 mAh/g from 4.2-2.2 V. A deeper depth of discharge from 2.2-1.5 V can add approximately 100 mAh/g or 40% more lithium capacity. FIG. 8 depicts a ZVO versus LFP discharge curve. In FIG. 8, the ZVO discharge curve is a solid line with an LFP discharge curve shown as a dashed line. The specific capacity of ZVO is 70% higher than LFP from 4.2-2.2 V and 143% higher than LFP from 4.2-2.0 V. FIG. 8 demonstrates a usable specific capacity of approximately 275 mAh/g from 4.2-2.2 V under a heated 55° C. formation cycle and 390 mAh/g from 2.2-2.0 V or 40% more lithium capacity. The battery in FIG. 7 is achieving approximately 97% of the C_{T} from 4.2-2.2 V during the first discharge.

A voltage window of 4.2-1.5 V can pose a challenge for power electronics in some commercial applications due to a voltage drop of more than 50% based on the starting voltage. Therefore, the extra lithium capacity below 2.2 V is not used during cycling and that capacity can be used for other practical purposes within a battery system including:
a lithium-ion reserve to overcome first cycle capacity formation losses,
a lithium-ion reserve to overcome coulombic efficiency losses over many cycles with historically low coulombic efficiency negative electrodes such as graphite/silicon mixtures, silicon, lithium-metal, and/or
a lithium-ion reserve that deposits extra lithium-metal in anodeless battery systems to improve electrochemical performance and lifetime.

Unlike other pre-lithiation reagents that commonly result in inactive components after the formation cycle; the positive electrode material taught herein does not require any sacrificial additive or component but instead relies on the inherent specific capacity of the ZVO material composition to provide extra lithium capacity.

Distinct to previously attempted over lithiation of positive electrode materials such as Li_{1.2}NMC, ZVO is a positive electrode material that can store extra lithium capacity as shown FIGS. 7 and 8. The extra lithium capacity in ZVO can be easily accessible on the bottom of the voltage typically between 2.2-1.5 V where upon charging is transferred to the negative electrode and used to mitigate first cycle capacity loss. This is distinct from NCA and NMC positive electrode materials that indeed contain extra lithium capacity above 4.2 V wherein electrolyte and positive electrode active material (cathode active material; CAM) stability of these layered intercalation materials rapidly degrades cycle life. This phenomenon is often observed at high voltages above 4.2 V where the CAM particles crack, resulting in fresh positive electrode surfaces that consume more lithium capacity to build additional passivation layers on the newly formed surfaces, further exacerbating CE capacity loss.

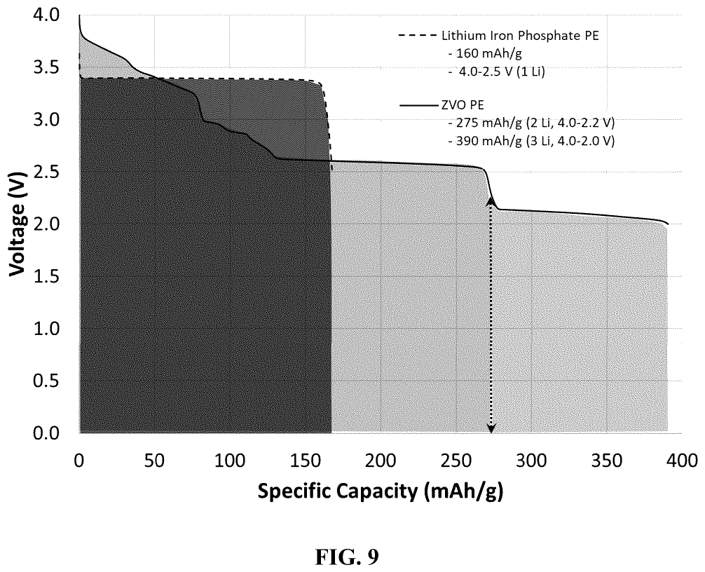

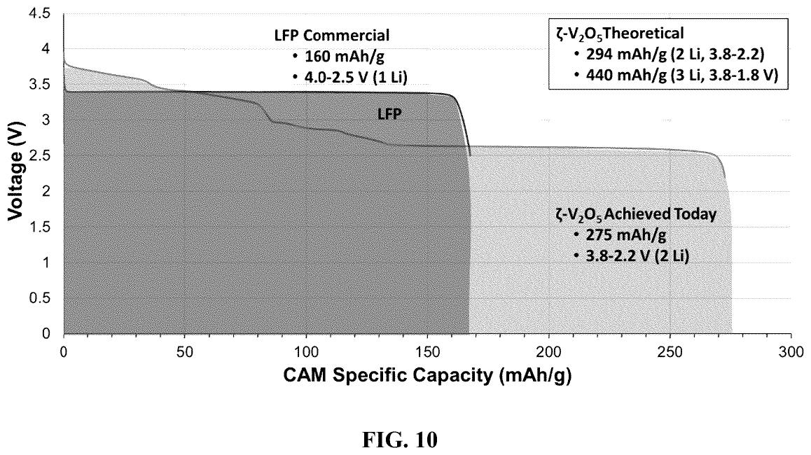

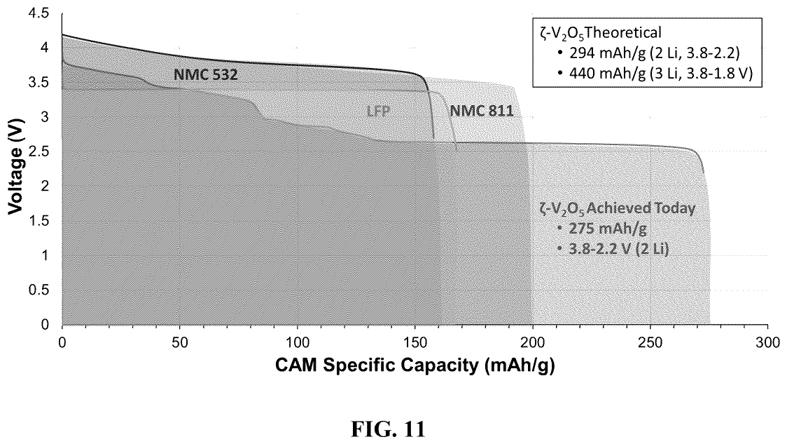

FIGS. 9-11 compare typical discharge curves of commercially available CAMs such as LFP, NMC 532, and NMC 811 to ZVO. FIG. 9 shows a ZVO discharge curve over the discharge curve for LFP. In FIG. 9, the ZVO discharge curve is a solid line with the LFP discharge curve shown as a dashed line. The specific capacity of ZVO is 70% higher than LFP from 4.2-2.2 V and 143% higher than LFP from 4.2-2.0 V. FIG. 10 shows a ZVO versus LFP discharge curve from 4.2-2.2. FIG. 11 shows discharge curves for ZVO versus LFP, NMC 532, and NMC 811 PE.

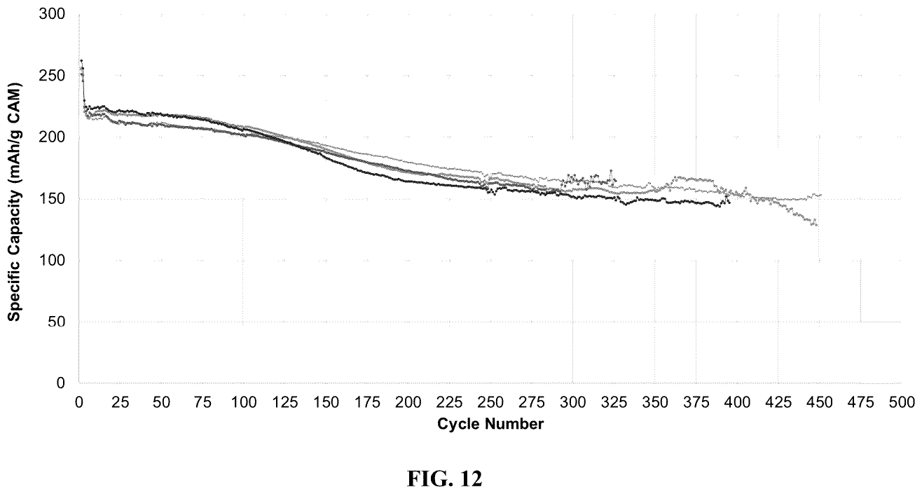

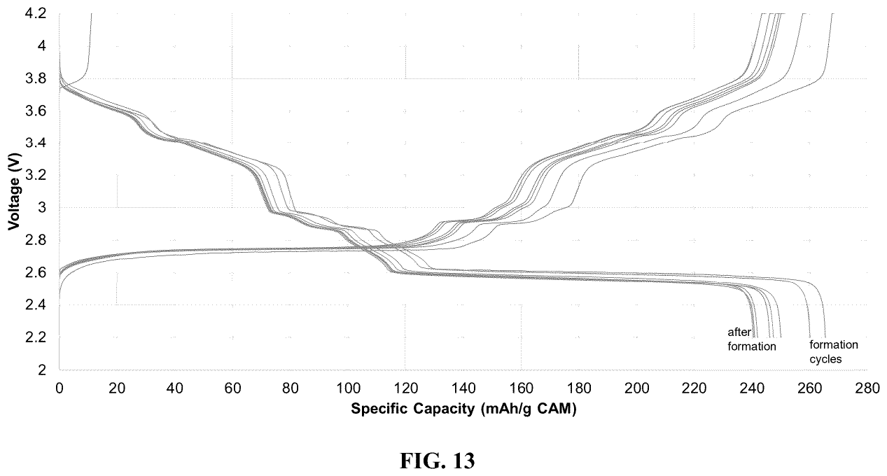

FIGS. 12 and 13 are representative examples of cycle life versus specific capacity and voltage versus specific capacity for ZVO positive electrodes paired with lithium metal negative electrodes. In FIG. 12, the first two charge/discharge cycles are performed at a symmetric C-rate of C/20 (the equivalent of 20 hours of discharge followed by 20 hours of charge) achieving approximately 250-260 mAh/g of specific capacity. Cycle 3 starts a symmetric C/5 charge/discharge cycle and achieves approximately 250 cycles at 80% capacity retention. In FIG. 13, the first two cycles at C/20 achieve a specific capacity of 265 and 260 mAh/g capacity, a 1.9% first to second cycle capacity loss. The following C/5 cycles achieve>240 mAh/g.

The extra lithium capacity from 2.2-1.5 V combined with the crystallographic stability of the completely delithiated ZVO positive electrode material provides a unique solution to first cycle capacity losses and CE losses. Furthermore, charged state and discharged state ZVO is stable in the presence of electrolytes up to 300° C. with no evidence of oxygen release or structural changes from differential scanning calorimetry.

With all these considerations a positive electrode material is presented for a rechargeable electrochemical cell that comprises a negative electrode, a positive electrode, and an electrolyte. The positive electrode material can comprise a compound with the general formula ζ-AₓM_{y}V₂O₅ and/or ζ-AₓM_{y}N_{z} V_{2-z}O₅, where M and N are transition metals, alkaline earths, alkalis, post-transition metals, metalloids, or a combination thereof and A can be one or more ions selected from the group consisting of Li, Na, K, Mg, Ca, Zn, and Al ions. The positive electrode material may be incorporated in rechargeable electrochemical cells operating in a voltage window between 1.5-4.5 V. The concentration of “A” as denoted by “x” can be between 0 and 3.0. The concentration of “M” as denoted by “y” can be between 0.00001 and 0.66. The concentration of “N” as denoted “z” can be between 0 and 1.33.

Some compositions of positive electrode material that have been found to be particularly effective include a positive electrode material wherein a concentration of “A” as denoted by “x” can be between 0-3, a concentration of “M” as denoted by “y” can be 0.0001-0.15, and where “M” can be one or more selected from the group consisting of Cu, Ag, Na, K, Mg, Ca, Pb, Al, Sn, Cs, Rb, and Fe.

Another effective composition of positive electrode material comprises a concentration of “A” as denoted by “x” can be between 0-3, a concentration of “M” as denoted by “y” can be between 0.0001-0.15, a concentration of “N” as denoted by “z” can be between 0-1.33, and where “N “is from the group consisting of W, Nb, Mo, Zr, Y, Hf, Cr, Sn, Fe, Ti, Mn, Ta, Ce, La, Ni, Si, Ga, Ge, and Co.

Some variations of the rechargeable electrochemical cell in which the positive electrode material is incorporated could have a negative electrode that is one of graphite, carbon, silicon, Li metal, Na metal, Mg metal, Ca metal, Zn metal, Al metal, and a combination thereof. In other variations of positive electrode material, the first cycle capacity loss associated with establishing a passivation layer can be mitigated by a reservoir of additional “A” ions above the concentration “x” used for cycling the rechargeable electrochemical cell. In other variations of positive electrode material, the rechargeable electrochemical cell has a lithium reservoir for passivation layer formation and operates in a voltage window between 2.0-4.5 V for cycling and below 2.0 V to access the lithium reservoir. In other variations of positive electrode material an intermittent charge/discharge cycling protocol is used wherein the charge/discharge cycles occur between 2.0-4.5 V and on-demand cycles between 1.5-4.5 V to deliver additional capacity to an external circuit. In other variations of positive electrode material, a continuous charge/discharge cycling protocol cycles from 1.5-4.5 V to deliver capacity to an external circuit.

In some aspects, what is presented is a rechargeable energy source system comprising: a negative electrode comprising lithium metal. In some variations, the lithium metal comprises a passivation layer. In some variations, the passivation layer comprises at least 10% of total lithium in the rechargeable energy source system. In some variations, the rechargeable energy source system comprises a positive electrode. In some variations, the positive electrode comprises vanadium atoms. In some variations, the rechargeable energy source system is configured to discharge between 2 and 4.5 V. In some variations, the rechargeable energy source system comprises a cycling efficiency of at least 98%.

In some variations, the passivation layer comprises at least 15%, 20%, 25%, 30%, or 33% of all lithium in the rechargeable energy source system. In some variations, the passivation layer comprises at most 15%, 20%, 25%, 30%, 33%, or 40% of all lithium in the rechargeable energy source system. In some variations, the passivation layer is a formation cycle passivation layer.

In some variations, the rechargeable energy source system is configured to discharge between 2.2 V to 4.2 V. In some variations, the rechargeable energy source system is configured to discharge between 2.5 V to 4 V. In some variations, the rechargeable energy source system is configured to discharge between 3 V to 3.5 V. In some variations, the cycling efficiency is at least 98.5%, 99%, 99.5%, 99.6%, 99.7%, 99.8%, or 99.9%. In some variations, the cycling efficiency is at most 98.5%, 99%, 99.5%, 99.6%, 99.7%, 99.8%, 99.9%, or 99.95%, or 99.99%.

In some variations, the positive electrode materials comprises V₂O₅. In some variations, the V₂O₅ comprises ζ-V₂O₅. In some variations, the V₂O₅ comprises nanostructures. In some variations, the nanostructures comprise nanowires. In some variations, the V₂O₅ comprises microstructures. In some variations, the microstructures are nonspherical and have an aspect ratio. In some variations, the V₂O₅ comprises microstructures and/or nanostructures. In some variations, the aspect ratio is at least 2, 3, 4, 5, 10, 15, 20, or 50 between the length and width of the microstructures or nanostructures.

In some aspects, what is presented is a rechargeable energy source system. In some variations, the rechargeable energy source system comprises a negative electrode. In some variations, the negative electrode comprises lithium metal. In some variations, the lithium metal comprises a passivation layer. In some variations, the passivation layer comprises at least 10% of total lithium in the rechargeable energy source system. In some variations, the rechargeable energy source system comprises a positive electrode. In some variations, the positive electrode comprises vanadium atoms. In some variations, the rechargeable energy source system is configured to discharge at voltages that includes a range. In some variations, the range is from 3 V to 3.5 V. In some variations, the rechargeable energy source system comprises a cycling efficiency of at least 98%. In some variations, the range comprises from 3 V to 4 V. In some variations, the range comprises from 2.5 V to 3.5 V. In some variations, the range comprises from 2.5 V to 4 V. In some variations, the range comprises from 2.2 V to 4.2 V. In some variations, the range comprises from 1.5-4.2 V. In some variations, the range comprises from 1.0-4.5 V.

In some aspects, what is presented is a method of using a rechargeable energy source system. In some variations, the method comprises providing a negative electrode and a positive electrode. In some variations, the positive electrode comprises a positive electrode. In some variations, the positive electrode material comprises vanadium atoms and lithium ions. In some variations, the method comprises forming a passivation layer on the negative electrode. In some variations, the method comprises forming a passivation layer on the negative electrode in a formation cycle. In some variations, the formation cycle comprises transferring the lithium ions to the negative electrode at a first range of voltages. In some variations, the method comprises discharging the rechargeable energy source system to transfer the lithium ions from the negative electrode to the positive electrode at a second range of voltages. In some variations, the second range of voltages is narrower than the first range of voltages.

In some variations, the first range comprises 0 V to 4.5 V. In some variations, the first range comprises 1.5 V to 4 V. In some variations, the first range comprises 2 V to 4 V. In some variations, the first range comprises 1.5 V to 4.2 V. In some variations, the second range comprises from 2 V to 4.5 V. In some variations, wherein the second range comprises from 2.2 V to 4.2 V. In some variations, the second range comprises from 2.5 V to 4 V. In some variations, the second range comprises from 3 V to 3.5 V. In some variations, the second range comprises from 3 V to 4 V. In some variations, the range comprises from 1.0 to 4.5 V.

In some variations, the positive electrode comprises V₂O₅. In some variations, the V₂O₅ comprises 2-V₂O₅. In some variations, the V₂O₅ comprises nanostructures. In some variations, the nanostructures comprise nanowires. In some variations, the V₂O₅ comprises microstructures. In some variations, the microstructures are nonspherical and have an aspect ratio. In some variations, the V₂O₅ comprises microstructures and/or nanostructures. In some variations, the aspect ratio is at least 2, 3, 4, 5, 10, 15, 20, or 50 between the length and width of the microstructures or nanostructures.

In some variations, a membrane may be disposed between the positive electrode and the negative electrode. In some variations, the membrane may selectively conduct lithium ions between the positive electrode and the negative electrode. In some variations, the membrane may substantially prevent or inhibit the passage organic solvents, anions of lithium salts, water, or a contaminant from being transferred between the negative electrode and the positive electrode. A membrane can comprise a single layer or multiple layers. In some variations, a membrane can comprise glass fiber, polyester, polyethylene, polypropylene, polyvinylidene fluoride (“PVDF”), polytetrafluoroethylene (“PTFE”), and a combination thereof. In some variations, a membrane can comprise hydrophobic polymers. In some variations, a membrane can comprise lithium-ion conductive channels.

In some variations, an electrolyte comprises an aqueous electrolyte. In some variations, an electrolyte comprises a non-aqueous electrolyte. In some variations, an electrolyte comprises a polymer electrolyte. In some variations, an electrolyte comprises an organic electrolyte. In some variations, an electrolyte comprises a lithium salt. In some variations, an electrolyte comprises an ionic liquid. In some variations, an electrolyte comprises a deep eutectic solvent. In some variations, an electrolyte can be a catholyte. In some variations, an electrolyte can be an anolyte. In some variations, an electrolyte can be a catholyte and an anolyte.

In some variations, an electrolyte is anhydrous. In some variations, an electrolyte is non-flammable or fire-resistant. In some variations, an electrolyte is self-extinguishing. In some variations, an electrolyte comprises additives, e.g., nitrogen, sulfur, phosphorus, or silicon compounds.

In some variations, an electrolyte comprises a decomposition potential of at least 2, 3, 4, 5, or 6 V. In some variations, an electrolyte comprises a decomposition potential of at most 2, 3, 4, 5, or 6 V. In some variations, an electrolyte comprises a dielectric constant of at least 2, 5, 10, 20, 30, 40, 50, 60, 70, or 80. In some variations, an electrolyte comprises a dielectric constant of at most 3, 5, 10, 20, 30, 40, 50, 60, 70, 80, or 90. An electrolyte can comprise various viscosities. Polymeric or polymer solution electrolytes can comprise a large viscosity, as the viscosity can scale exponentially with molecular weight of the polymer above a critical molecular weight (e.g., entanglement molecular weight). In some variations, an electrolyte comprises a viscosity of at least 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some variations, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 Pa·s. In some variations, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 kPa·s. In some variations, an electrolyte comprises a viscosity of at most 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some variations, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 Pas. In some variations, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 kPa·s.

Various organic electrolytes can be used. In some variations, an organic electrolyte can comprise dimethyl carbonate, ethylmethyl carbonate, diethyl carbonate, ethylene carbonate, propylene carbonate, 1,3-dioxolan-2-one, 4-methyl-1,3-dioxolan-2-one, oxolan-2-one, and any combination thereof. In some variations, an electrolyte can comprise an organic carbonate compound, an ester compound, an ether compound, a ketone compound, an alcohol compound, an aprotic bipolar solvent, or a combination thereof. The carbonate compound may be an open chain carbonate compound, a cyclic carbonate compound, a fluorocarbonate derivative thereof, or a combination thereof.

In some variations, the chain carbonate compound can be diethyl carbonate (“DEC”), dimethyl carbonate, (“DMC”), dipropyl carbonate (“DPC”), methylpropyl carbonate (“MPC”), ethylpropylcarbonate (“EPC”), methylethyl carbonate (“MEC”), and a combination thereof. In some variations, the cyclic carbonate compound can be ethylene carbonate (“EC”), propylenecarbonate (“PC”), butylene carbonate (“BC”), fluoroethylene carbonate (“FEC”), vinylethylene carbonate (“VEC”), and a combination thereof. In some variations, the fluorocarbonate compound can be fluoroethylene carbonate (“FEC”), 4,5-difluoroethylene carbonate, 4,4-difluoroethylene carbonate, 4,4,5-trifluoroethylene carbonate, 4,4,5,5-tetrafluoroethylene carbonate, 4-fluoro-5-methylethylene carbonate, 4-fluoro-4-methylethylene carbonate, 4,5-difluoro-4-methylethylene carbonate, 4,4,5-trifluoro-5-methylethylene carbonate, trifluoromethylethylene carbonate, and a combination thereof. In some variations, the carbonate compound may include a combination of cyclic carbonate and chain carbonate, in consideration of dielectric constant and viscosity of the electrolyte. In some variations, the carbonate compound may be a mixture of such chain carbonate and/or cyclic carbonate compounds as described above with a fluorocarbonate compound. In some variations, the fluorocarbonate compound may increase solubility of a lithium salt to improve ionic conductivity of the electrolyte, and may facilitate formation of the thin film on the negative electrode. In some variations, the ester compound is methyl acetate, ethyl acetate, n-propyl acetate, dimethyl acetate, methyl propionate (“MP”), ethyl propionate, γ-butyrolactone, decanolide, valerolactone, mevalonolactone, caprolactone, and methyl formate. In some variations, the ether compound is dibutyl ether, tetraglyme, diglyme, 1,2-dimethoxyethane, 1,2-diethoxyethane, ethoxymethoxyethane, 2-methyltetrahydrofuran, and tetrahydrofuran. An example of the ketone compound is cyclohexanone. In some variations, the alcohol compound can be ethyl alcohol or isopropyl alcohol. In some variations, the aprotic solvent can be a nitrile (such as R—CN, wherein R is a C₂-C₂₀ linear, branched, or cyclic hydrocarbon-based moiety that may include a double-bond, an aromatic ring or an ether bond), amides (such as formamide and dimethylformamide), dioxolanes (such as 1,2-dioxolane and 1,3-dioxolane), methylsulfoxide, sulfolanes (such as sulfolane and methylsulfolane), 1,3-dimethyl-2-imidazolidinone, N-methyl-2-pyrrolidinone, nitromethane, trimethyl phosphate, triethyl phosphate, trioctyl phosphate, and triester phosphate. In some variations, an electrolyte can comprise an aromatic hydrocarbon organic solvent in a carbonate solvent. In some variations, an aromatic hydrocarbon organic solvent can be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, 3,5-difluorotoluene, 2,3,4-trifluorotoluene, 2,3,5-trifluorotoluene, 2,3,6-trifluorotoluene, 3,4,5-trifluorotoluene, 2,4,5-trifluorotoluene, 2,4,6-trifluorotoluene, 2-chlorotoluene, 3-chlorotoluene, 4-chlorotoluene, 2,3-dichlorotoluene, 2,4-dichlorotoluene, 2,5-dichlorotoluene, 2,6-dichlorotoluene, 2,3,4-trichlorotoluene, 2,3,5-trichlorotoluene, 2,3,6-trichlorotoluene, 3,4,5-trichlorotoluene, 2,4,5-trichlorotoluene, 2,4,6-trichlorotoluene, 2-iodotoluene, 3-iodotoluene, 4-iodotoluene, 2,3-diiodotoluene, 2,4-diiodotoluene, 2,5-diiodotoluene, 2,6-diiodotoluene, 3,4-diiodotoluene, 3,5-diiodotoluene, 2,3,4-triiodotoluene, 2,3,5-triiodotoluene, 2,3,6-triiodotoluene, 3,4,5-triiodotoluene, 2,4,5-triiodotoluene, 2,4,6-triiodotoluene, o-xylene, m-xylene, p-xylene, and combinations thereof.

Various polymeric electrolytes can be used. A polymer electrolyte can comprise poly(ethylene oxide), poly(vinyl alcohol), poly(methyl methacrylate), poly(caprolactone), poly(chitosan), poly(vinyl pyrrolidone), poly(vinyl chloride), poly(vinyl fluoride), poly(imide), or any combination thereof, which can inherently conduct lithium ions or be doped with one or more lithium salts to make the polymer be lithium conductive.

Various ionic liquids can be used, e.g., any one of the ionic liquids listed on the Ionic Liquids Database (ILThermo) of the National Institute of Standards and Technology.

Various lithium salts can be used. A lithium salt can comprise lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hexafluorophosphate, lithium hypochlorite, lithium hypofluorite, lithium metaborate, lithium methoxide, lithium naphthalene, lithium niobate, lithium nitrate, lithium nitrite, lithium oxalate, lithium perchlorate, lithium stearate, lithium succinate, lithium sulfate, lithium sulfide, lithium superoxide, lithium tantalate, lithium tetrachloroaluminate, lithium tetrafluoroborate, lithium tetrakis(pentafluorophenyl) borate, lithium triflate, lithium tungstate, or any combination thereof. In some variations, an electrolyte can comprise lithium salts comprising an organic anion selected from the group consisting of trifluoromethanesulfonyl-imide (TFSI), N-butyl-N-methylpyrrolidinium bis(trifluoromethanesulfonyl)imide (PyruTFSI), trifluoromethanesulfonyl-imide, bis(trifluoromethanesulfonyl)imide (LiTFSI), and 1-ethyl-3-methylimidazolium-bis(trifluoromethylsulfonyl)imide (EMI-TFSI). In some variations, the catholyte 290 comprises ionic liquid-forming salts dissolved in 1,3-dioxolane (DOL), 1,2 dimethoxyethane (DME), or tetraethylene glycol dimethyl ether (TEGDME). In some variations, an electrolyte can comprise Li₂SO₄, Li₂CO₃, LiPF₆, LiBF₄, LiClO₄, LiTFSI, and combinations thereof. In some variations, an electrolyte can comprise LiPF₆, LiBF₄, LiSbF₆, LiAsF₆, LiSbF₆, LiCF₃SO₃, Li(CF₃SO₂)₃C, Li(CF₃SO₂)₂N, LiC₄F₉SO₃, LiClO₄, LiAlO₄, LiAlCl₄, LiAlF₄, LiBPh₄, LiBiOCl, CH₃SO₃Li, C₄F₃SO₃Li, (CF₃SO₂)₂NLi, LiN(CₓF₂ₓ₊₁SO₂) (CₓF_{2y+1}SO₂) (wherein x and y are natural numbers), CF₃CO₂Li, LiCl, LiBr, LiI, LIBOB (lithium bisoxalato borate), lower aliphatic carboxylic acid lithium, lithium terphenylborate, lithium imide, and any combination thereof. In some variations, a concentration of the lithium salt may be in a range of about 0.1 molar (“M”) to about 2.0 M. In some variations, a concentration of the lithium salt is at least 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M. In some variations, a concentration of the lithium salt is at most 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M.

A separator can be provided between a negative electrode and a positive electrode. The separator can be in contact with the layer of lithium metal. The separator can be in contact with the positive electrode.

The separator can comprise a polymer or a ceramic membrane. The separator can be wetted with an electrolyte. The separator can comprise a surface that is substantially non-reactive with lithium metal.

The separator can comprise a polypropylene surface. The separator can comprise a single layer or multiple layers. The separator can comprise glass fiber, polyester, Teflon, polyethylene, polypropylene, polyvinylidene fluoride (“PVDF”), polytetrafluoroethylene (“PTFE”), or a combination thereof. The separator can comprise at least three layers. The at least three layers can comprise polypropylene, polyethylene, and polypropylene, in order.

The separator can have a porosity of at least 10, 20, 30, 40, 50, 60, 70, or 80 percent. The separator can have a porosity of at most 10, 20, 30, 40, 50, 60, 70, or 80 percent. The separator can have a porosity of at least 55%. The separator can have a porosity of at most 55%. The separator can have a porosity of about 55%.

The separator can be at least 5, 10, 15, 20, 25, 30, 35, 40, 45, or 50 μm thick. The separator can be at most 5, 10, 15, 20, 25, 30, 35, 40, 45, or 50 μm thick. The separator can be 5 to 50 μm thick.

The separator can selectively conduct lithium ions between the negative electrode and the positive electrode. The separator can substantially prevent or inhibit the passage of organic solvents, anions of lithium salts, water, or a contaminant from being transferred between the negative electrode and the positive electrode. The separator can hydrophobic polymers. The separator can comprise lithium-ion conductive channels.

The positive electrode material can comprise a binder. The binder can bind the positive electrode material to the current collector. The binder can be electrically conductive. The binder can comprise polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (“SBR”), acrylated SBR, epoxy resin, and nylon. The binder can comprise carbon black or vapor ground carbon fibers. The binder can be polyvinylidene fluoride (PVDF), sodium alginate, and sodium carboxymethyl cellulose. The binder can comprise PVDF, polytetrafluoroethylene (PTFE), styrene butadiene rubber (SBR), and polyimide. The binder can graphene or carbon nanotubes.

The positive electrode material can comprise a surface coating. The surface coating can comprise an oxide, a hydroxide, an oxyhydroxide, an oxycarbonate, or a hydroxycarbonate. The surface coating can be amorphous or crystalline. The surface coating can comprise magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr) atoms, or any combination thereof. The surface coating can be formed using a spray coating method, a dipping method, or any other suitable method.

The positive electrode material can comprise a polymer binder. The polymer binder can comprise a block copolymer. The block copolymer can provide a hydrophobic domain on a surface of the electrode. A hydrophobic polymer membrane can be bound to the hydrophobic domain on the surface of the positive electrode material.

The substrate can comprise a current collector. The current collector can comprise copper, stainless steel, aluminum, nickel, titanium, sintered carbon, copper or stainless steel that is surface-treated with carbon, nickel, titanium or silver, and aluminum-cadmium alloys. The current collector can comprise various forms including films, sheets, foils, nets, porous structures, foams, and non-woven fabrics. The current collector can comprise carbon, carbon paper, carbon cloth or a metal or noble metal mesh or foil. The current collector can comprise fine irregularities on surfaces thereof so as to enhance the adhesive strength of the current collector to the positive electrode material. The current collector can have a thickness of at least 1, 2, 3, 4, 5, 6, 7, 8, 9, 10, 20, 30, 40, 50, 60, 70, 80, 90, 100, 200, 300, 400, 500, 600, 700, 800, 900, or 1000 μm. The current collector can have a thickness of at most 1, 2, 3, 4, 5, 6, 7, 8, 9, 10, 20, 30, 40, 50, 60, 70, 80, 90, 100, 200, 300, 400, 500, 600, 700, 800, 900, or 1000 μm.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

### EXAMPLES

The following examples are provided to further illustrate some variations of the present disclosure, but are not intended to limit the scope of the disclosure; it will be understood by their exemplary nature that other procedures, methodologies, or techniques known to those skilled in the art may alternatively be used.

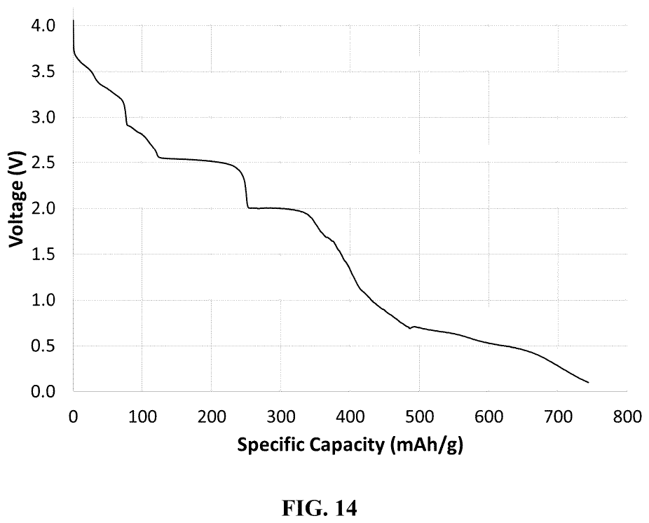

For simplicity, in the following examples the element A in ζ-AₓM_{y}V₂O₅ and/or ζ-AₓM_{y}N_{z} V_{2-z}O₅ is Li and written as ζ-LiₓM_{y}V₂O₅ and/or ζ-LiₓM_{y}N_{z}V_{2-z}O₅, where x is the concentration of lithium between 0-3. The remainder of the vanadium compound having zeta vanadium oxide is denoted as ZVO. Therefore, the chemical formula can be represented by LiₓZVO. The concentration of Li as denoted by x is correlated to positive electrode areal density and negative electrode areal density (mAh/cm²). LiₓZVO can be stable at all concentrations of x from 0-3 lithium under ambient conditions. In FIG. 14 shows that the concentration of x in LiₓZVO can achieve values greater than 3 with an obtained specific capacity of more than 700 mAh/g, x equal to approximately 5 lithium, from 4.2-0.1 V. The voltage windows and concentration of lithium in LiₓZVO can be adjusted to (1) increase or decrease the capacity of the positive electrode as needed and by design, (2) mitigate capacity losses, and (3) improve performance. For example, the upper voltage of 4.2 V can reasonable be reduced to 4.0 V with little loss in capacity or reduced further to 3.8 V to limit electrolyte decomposition but at a slight loss in positive electrode capacity. Furthermore, the cell voltage (E_{cell}) can change based on the reduction potential of the negative electrode (E_{NE}) and the positive electrode (E_{PE}) according to E_{cell}=E_{PE}−E_{NE}.

### Example 1: Li_{2.5}ZVO Positive Electrode with Graphite Negative Electrode (Ratio of Negative Electrode to Positive Electrode is 1.125)

A Li_{2.5}ZVO based positive electrode is combined with a graphite negative electrode, a polymeric separator, and electrolyte/solvent. The Li_{2.5}V₂O₅ positive electrode has a starting areal density of 5.0 mAh/cm² between 4.0-1.3 V and 4.0 mAh/cm² between 4.0-2.0 V. The positive electrode Li_{2.5} V₂O₅ is paired with a graphite negative electrode that has areal density of 4.5 mAh/cm². During the first charge formation cycle the entire 5.0 mAh/cm² is consumed and split between the negative electrode (90% or 4.5 mAh/cm²) and the passivation layer (10% or 0.5 mAh/cm²). During the first discharge 4.0 mAh/cm² are used from 4.0-2.0 V leaving 0.5 mAh/cm² within the negative electrode as reserve for coulombic efficiency losses. In this example, the extra 0.5 mAh/cm² overbalance of the positive electrode during the first charge cycle has the potential to plate lithium metal onto the negative electrode surface. The negative electrode to positive electrode capacity ratio is designed to be 1.125 from 4.0-2.0 V.

### Example 2: Li_{2.5}ZVO Positive Electrode with Graphite Negative Electrode (Ratio of Negative Electrode to Positive Electrode is 1.375)

A Li_{2.5}ZVO based positive electrode is combined with a graphite negative electrode, a polymeric separator, and electrolyte/solvent. The Li_{2.5}V₂O₅ positive electrode has a starting areal density of 5.0 mAh/cm² between 4.0-1.3 V and is paired with a graphite negative electrode that has areal density of 5.5 mAh/cm². During the first charge formation cycle the entire 5.0 mAh/cm² is consumed and split between the negative electrode (90% or 4.5 mAh/cm²) and the passivation layer (10% or 0.5 mAh/cm²). In this example, the extra 0.5 mAh/cm² overbalance of the negative electrode during the first charge cycle eliminates the potential to plate lithium metal onto the negative electrode surface. During the first discharge 4.0 mAh/cm² are used from 4.0-2.0 V leaving 0.5 mAh/cm² within the negative electrode as reserve for coulombic efficiency losses. The negative electrode to positive electrode capacity ratio is designed to be 1.375.

### Example 3:Li_{2.7}ZVO Positive Electrode with Graphite/Silicon Negative Electrode (1.08 NE:PE Design Ratio)

A Li_{2.7}ZVO based positive electrode is combined with a graphite/silicon (10% Si) negative electrode, a polymeric separator, and electrolyte/solvent. The Li_{2.7}V₂O₅ positive electrode has a starting areal density of 6.75 mAh/cm² (4.0-1.3V) and is paired with a graphite negative electrode that has areal density of 5.4 mAh/cm². During the first charge formation cycle the entire 6.75 mAh/cm² is consumed and split between the negative electrode (80% or 5.4 mAh/cm²) and the passivation layer (20% or 1.35 mAh/cm²). In this example, the extra 1.35 mAh/cm² overbalance of the positive electrode during the first charge cycle has the potential to plate lithium metal onto the negative electrode surface. During the first discharge 5.0 mAh/cm² are used from 4.0-2.0 V leaving 0.4 mAh/cm² within the negative electrode as reserve for coulombic efficiency losses. The negative electrode to positive electrode capacity ratio is designed to be 1.08 from 4.0-2.0 V.

### Example 4: Li_{2.5}ZVO Positive Electrode with Graphite/Silicon Negative Electrode (Ratio of Negative Electrode to Positive Electrode is 1.30)

A Li_{2.5}ZVO based positive electrode is combined with a graphite/silicon (10% Si) negative electrode, a polymeric separator, and electrolyte/solvent. The Li_{2.5}V₂O₅ positive electrode has a starting areal density of 5.0 mAh/cm² (4.0-1.3V) and is paired with a graphite negative electrode that has areal density of 5.2 mAh/cm². During the first charge formation cycle the entire 5.0 mAh/cm² is consumed and split between the negative electrode (80% or 4.0 mAh/cm²) and the passivation layer (20% or 1.0 mAh/cm²). In this example, the extra 0.2 mAh/cm² overbalance of the negative electrode during the first charge cycle has eliminated the potential to plate lithium metal onto the negative electrode surface. During the first discharge 4.0 mAh/cm² are used from 4.0-2.0 V. The negative electrode to positive electrode capacity ratio is designed to be 1.30 from 4.0-2.0 V.

### Example 5: Li₀ZVO with Li-Metal Negative Electrode

A Li₀ZVO based positive electrode is combined with a lithium metal negative electrode, a polymeric separator, and electrolyte/solvent. The Li₀ZVO positive electrode has a starting areal density of 4.0 mAh/cm² and is paired with a lithium metal negative electrode that has an areal density of 8.2 mAh/cm². A high areal density for lithium metal deposited on a copper current collector is advantageous because it allows for an easily manufacturable 40-micron thick lithium metal layer on copper foil. During the first discharge 4.0 mAh/cm² are used from 4.2-2.2 V leaving 4.2 mAh/cm² within the negative electrode as a reserve for coulombic efficiency losses.

### Example 6: Li₀ZVO with Li-Metal Laminated Graphite Negative Electrode (Ratio of Negative Electrode to Positive Electrode is 1.30)

A Li₀ZVO based positive electrode is combined with a combination lithium metal/graphite negative electrode, a polymeric separator, and electrolyte/solvent. The Li₀ZVO positive electrode has a starting areal density of 5.0 mAh/cm² (4.2-1.3 V) and is paired with a lithium metal negative electrode that has an areal density of 4.5 mAh/cm² stacked on top of a graphite negative electrode with an areal density of 5.0 mAh/cm². During the first discharge formation cycle 4.5 mAh/cm² of the lithium metal negative electrode (all the lithium metal negative electrode) are consumed from 4.2-1.3 V. The extra 0.5 mAh/cm² from the deeper depth of discharge ensures complete consumption of the lithium metal laminating layer via intercalation into the positive electrode. During the first charge 4.0 mAh/cm² are used for the negative electrode (88%) and 0.5 mAh/cm² (11%) is consumed by passivation layer formation. FIG. 4 depicts a schematic of the cell design with a laminated lithium metal layer on a graphite negative electrode.

### Example 7: Li₃ZVO with Copper Foil Negative Electrode (Often Referred to as an Anodeless Design)

A Li₃ZVO based positive electrode is combined with a copper foil current collector, a polymeric separator, and electrolyte. The Li₃ZVO positive electrode has a starting areal capacity of 6.0 mAh/cm² from 4.2-1.5 V and is paired with copper foil that has no starting capacity. This often referred to as an anodeless design in literature. During the first discharge 6.0 mAh/cm² of Li₃ZVO are consumed from 4.2-1.5 V. During the first charge 4.0 mAh/cm² are used from 4.2-2.2 V and the remaining 2.0 mAh/cm² or approximately 10-micron thick lithium metal remain on the negative electrode establishing an in-situ lithium metal anode.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1-53. (canceled)

54. A rechargeable energy source system, comprising:
a negative electrode;
an electrolyte; and
a positive electrode, wherein the positive electrode comprises a compound having a structure of ζ-AₓM_{y}N_{z}V_{2-z}O₅.

55. The rechargeable energy source system of claim 54, wherein A comprises one or more ions selected from the group consisting of Li, Na, K, Mg, Ca, Zn, and Al ions.

56. The rechargeable energy source system of claim 54, wherein x ranges from about 0 to about 3.

57. The rechargeable energy source system of claim 54, wherein M comprises a transition metal, an alkaline earth metal, an alkali metal, a post-transition metal, a metalloid, or a combination thereof.

58. The rechargeable energy source system of claim 54, wherein y ranges from about 0.00001 to about 0.66.

59. The rechargeable energy source system of claim 58, wherein y ranges from about 0.0001 to about 0.2.

60. The rechargeable energy source system of claim 54, wherein M comprises one or more ions selected from the group consisting of Na, K, Mg, Ca, Pb, Al, Sn, Cs, Rb, and Fe ions.

61. The rechargeable energy source system of claim 54, wherein N comprises a transition metal, a post-transition metal, a metalloid, or a combination thereof.

62. The rechargeable energy source system of claim 54, wherein z ranges from about 0 to about 2.

63. The rechargeable energy source system of claim 62, wherein z ranges from about 0 to about 1.33.

64. The rechargeable energy source system of claim 54, wherein N comprises one or more ions selected from the group consisting of W, Nb, Mo, Zr, Y, Hf, Cr, Sn, Fe, Ti, Mn, Ta, Ce, La, Ni, Si, Ga, Ge, and Co ions.

65. The rechargeable energy source system of claim 54, wherein the negative electrode comprises lithium metal.

66. The rechargeable energy source system of claim 65, wherein the negative electrode forms a passivation layer by transferring the lithium ions to the negative electrode at a voltage from about 0 V to about 4.5 V.

67. The rechargeable energy source system of claim 66, wherein the passivation layer comprises at least 10% of total lithium in the rechargeable energy source system.

68. The rechargeable energy source system of claim 66, wherein the passivation layer comprises at most 15%, 20%, 25%, 30%, or 33% of total lithium in the rechargeable energy source system.

69. The rechargeable energy source system of claim 54, wherein the rechargeable energy source system is configured to discharge from about 2 V to about 4.5 V.

70. The rechargeable energy source system of claim 54, wherein the rechargeable energy source system is configured to discharge from about 2.2 V to about 4.2 V.

71. The rechargeable energy source system of claim 54, wherein the rechargeable energy source system comprises a cycling efficiency of at least 98%.

72. The rechargeable energy source system of claim 71, wherein the rechargeable energy source system comprises a cycling efficiency of at least 98.5%, 99%, 99.5%, 99.6%, 99.7%, 99.8%, or 99.9%.

73. The rechargeable energy source system of claim 72, wherein the rechargeable energy source system comprises a cycling efficiency greater than 99.98% over 1000 cycles.
